(19) United States
(12) Patent Application Publication
(10) Pub. No.: US 2017/0316004 A1
(43) Pub. Date: Nov. 2, 2017

(54) ONLINE ENGINE FOR 3D COMPONENTS

(71) Applicant: Microsoft Technology Licensing, LLC, Redmond, WA (US)

(72) Inventors: Neal Osotio, Sammamish, WA (US); YoungSun Park, Bellevue, WA (US)

(21) Appl. No.: 15/141,809

(22) Filed: Apr. 28, 2016

(51) Int. Cl. G06F 17/30; G06N 99/00; G06T 19/00; G06F 3/16

(52) U.S. Cl. CPC G06F 17/3053; G06T 19/00; G06F 3/167; G06F 17/30554; G06N 99/005

(57) ABSTRACT

Techniques for designing an online engine generating 3D components responsive to user queries. In an aspect, the online engine receives workflow data generated by a user. The workflow data is used to train one or more machine learning algorithms to serve relevant results to a user query. In an aspect, the results may include a 3D component corresponding to parameters of a 3D model that may be served to the user responsive to the query. The retrieved 3D component may be selected and manipulated by the user as part of a virtual or augmented reality system for creating and/or editing one or more project files.

### BACKGROUND

With the advent of technology for visualizing and processing information in three dimensions (3D), the use of virtual and augmented reality systems in business, academic, and research settings will be increasingly widespread. Users of such systems may view models of their projects in 3D space, e.g., while wearing glasses that stereoscopically display 3D renderings of their models. Users will further be enabled to design and manipulate 3D models using voice and input modalities such as 2D or 3D hand gestures.

To facilitate the creation and modification of new 3D content, it would be advantageous to allow users to retrieve information from the Internet in a seamless and intuitive way during their project workflows. For example, while designing a 3D model of a new building, an architect may desire to locate pre-existing information and data on some component of the building, e.g., a roof configuration. It would be desirable to provide a system that can process queries for such information in an efficient manner. It would further be desirable to retrieve online 3D components based on such queries, and enable the user to readily integrate such retrieved 3D components into an existing 3D workflow.

### BRIEF DESCRIPTION OF THE DRAWINGS

FIG 1 illustrates a first illustrative scenario showing various aspects of the present disclosure.

FIG. 2 illustrates an exemplary embodiment of a method for a workflow utilizing the system described herein.

FIG. 3 illustrates an alternative exemplary embodiment of a method for a workflow according to the present disclosure.

FIG. 4 illustrates an application of the workflow of FIG. 3 to a design environment.

FIG. 5 illustrates an exemplary embodiment of a system for implementing the functionality described hereinabove.

FIG. 6 illustrates an exemplary embodiment of a method executed by a computer during the workflow of FIG. 3.

FIG. 7 illustrates an exemplary embodiment of a method executed by a server during the workflow of FIG. 3.

FIG. 8 illustrates an exemplary embodiment of a method executed by an online engine during the workflow of FIG. 3.

FIG. 9 illustrates an exemplary embodiment of a method according to the present disclosure.

FIG. 10 illustrates an exemplary embodiment of an apparatus according to the present disclosure

FIG. 11 illustrates an alternative exemplary embodiment of an apparatus according to the present disclosure.

FIG. 12 illustrates an exemplary embodiment f a computing device according to the present disclosure.

### DETAILED DESCRIPTION

Various aspects of the technology described herein are generally directed towards techniques for a system that can process queries in a workflow for creating 3D content, and retrieve online 3D components that may be readily integrated the existing workflow.

The detailed description set forth below in connection with the appended drawings is intended as a description of exemplary means “serving as an example, instance, or illustration,” and should not necessarily be construed as preferred or advantageous over other exemplary aspects. The detailed description includes specific details for the purpose of providing a thorough understanding of the exemplary aspects of the invention. It will be apparent to those skilled in the art that the exemplary aspects of the invention may be practiced without these specific details. In some instances, well-known structures and devices are shown in block diagram form in order to avoid obscuring the novelty of the exemplary aspects presented herein.

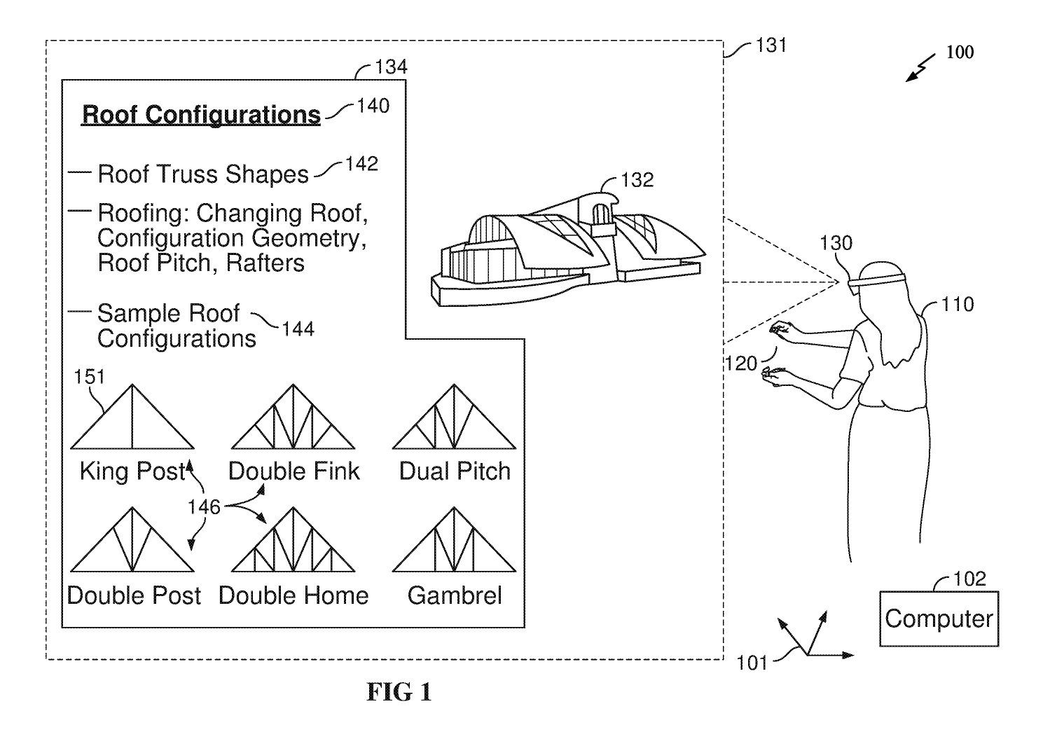

FIG. 1 illustrates a first illustrative scenario 100 showing various aspects of the present disclosure. Note scenario 100 is shown for illustrative purposes only, and is not meant to limit the scope of the present disclosure, e.g., to any particular types of models (e.g., architectural, fashion, industrial design, etc.) to be manipulated, supported modes of input/output interface, specific knowledge areas, search results, or other information shown or suggested.

In FIG. 1, system 101 provides a “virtual” or “augmented” reality interface to user 110 to provide an immersive digital experience. In particular, user 110 may wear interactive glasses 130, which presents to user 110 digitally formed imagery 131, also denoted “virtual” or “augmented” imagery. Note imagery 131 shown in FIG. 1 is meant to illustratively suggest what is seen by user 110 through glasses 130, and thus FIG. 1 is not meant to suggest any particular spatial relationship (e.g., size, orientation, directionality, etc.) of imagery 131 to user 110. Imagery 131 may include text, pictures, video, and/or other graphics, etc. It will be appreciated that imagery 131 is shown for illustrative purposes only, and is not meant to limit the scope of the present disclosure to any particular type of imagery that can be accommodated by the techniques disclosed herein.

In scenario 100, imagery 131 displayed by glasses 130 may include a digitally formed three-dimensional (3D) model or component 132 of a structure, corresponding to a project being worked on by user 110, and query data 134, corresponding to data relevant to the project being worked on. Such a 3D model, and any other aspect of imagery 131, may be presented stereoscopically (i.e., “three-dimensionally” or “in 3D”), e.g., glasses 130 may provide, e.g., the sensation of depth to user 110, by presenting distinct images to the left and right eyes of user 130. In this Specification and in the Claims, a “3D component” may denote parameters associated with any imagery that can be presented stereoscopically, or alternatively, any aspect of imagery having a perspective-dependent component.

Further in scenario 100, user 110 may “interact” with certain aspects of imagery 131, e.g., by providing an input through one or more input modalities supported by system 101 to modify imagery 131 or any other system parameters. Such input modalities may include, but are not limited to, hand gesturing, voice control, eye gazing, etc. In an exemplary embodiment, by moving her hands to produce one or more specific gestures 120 in two or even three dimensions, user 110 may change the way in which component 132 in imagery 131 is displayed, e.g., by tilting, zooming, rotating component 132, adding or removing components, or otherwise modifying any aspect of imagery 131. In an exemplary embodiment, user 110 may also provide speech input to system 101 that may be processed using voice/speech recognition sub-modules (not explicitly shown in FIG. 1). Note the input modalities are described herein for illustrative purposes only, and are not meant to limit the scope of the present disclosure to any particular types of input modalities that can be processed by a system.

In an exemplary embodiment, computer 102 of system 101 may communicate with glasses 130 (e.g., over wired cables or wirelessly), and required functionality for creating, processing, or modifying imagery 131 may be shared or divided amongst glasses 130, computer 102, and/or other processing modules (not shown). Furthermore, computer 102 or glasses 130 may also be coupled to a plurality of sensors (not shown) for collecting one or more types of input signals provided by user 110. For example, a microphone (not shown) may be provided to receive voice input from user 110, one or more motion/spatial sensors (not shown) may detect and/or interpret hand gestures 120, etc.

In scenario 100, input received through the one or more modalities supported by system 101 may relate to queries by user 110 for certain types of information. For example, in an exemplary embodiment, user 110 is an architect who uses system 101 to design and/or modify a 3D component 132 of a building for an architectural project. Note while an exemplary embodiment is described herein showing an application of system 101 to the field of architectural design, the techniques disclosed herein may readily be applied to any other fields that may benefit from 3D visualization (including, but not limited to, e.g., all types of industrial design, scientific research, medical applications, engineering, etc.). Such alternative exemplary embodiments are contemplated to be within the scope of the present disclosure.

While user 110 is using system 101, she may come across the need to learn more about a specific topic related to the project. For example, when working on the architectural project, user 110 may need to learn more about specific roofing configurations. In this case, user 110 may submit a query for “roof configurations” to system 101, e.g., by repeating a phrase such as “query roof configurations” with her voice, or using any other supported input modality. In an exemplary embodiment, system 101 may receive the query for “roof configurations” using one or more microphones and/or speech recognition modules, and retrieve information relevant to and responsive to the query from one or more predetermined sources.

In an exemplary embodiment, system 101 may be connected to a local network or to the World Wide Web (not shown). For example, computer 102 may submit the query to one or more databases located on such network or on the World Wide Web, and retrieve the relevant information. In an exemplary embodiment, such databases may correspond to a search engine, e.g., an Internet search engine. Computer 102 may retrieve results from such databases relevant to the user query.

For example, responsive to a user query for “roof configurations,” computer 102 may retrieve results and present those results as data 134 within imagery 131. In scenario 100, data 134 is illustratively shown to include a query-dependent heading 140, results 142 relevant to the query, and a collection 144 of sample roof configurations 146 (e.g., text and/or two-dimensional images relating to such roof configurations). Note data 134 is described for illustrative purposes only, and is not meant to limit the scope of the present disclosure to any particular types or formats of results that may be retrieved in response to a user query.

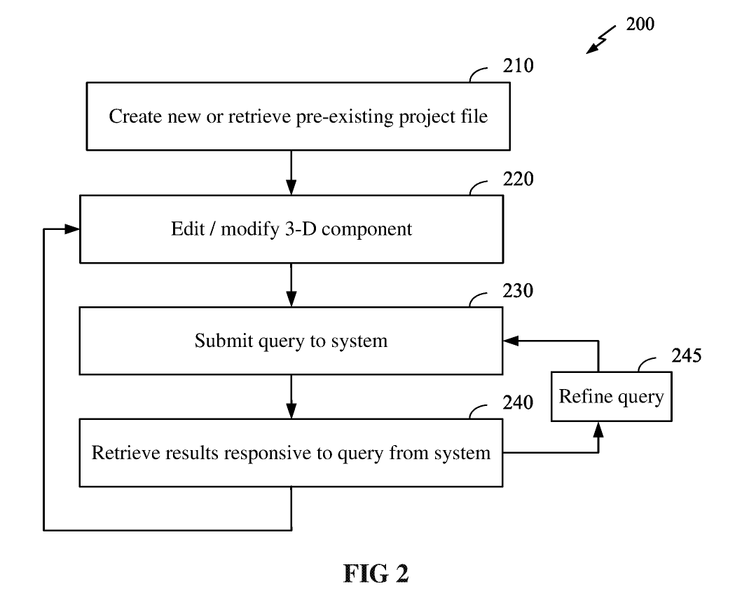

FIG. 2 illustrates an exemplary embodiment of a method 200 for a workflow utilizing system 101 according to the present disclosure. Note FIG. 2 is shown for illustrative purposes only, and is not meant to limit the scope of the present disclosure to any particular workflow or sequence utilizing system 101.

In FIG. 2, at block 210, a user may create a new project file, or retrieve a pre-existing one from system 101,

At block 220, a user may edit or modify a 3D component. The 3D component may be stored in the project file. For example, with reference to scenario 100, user 110 may edit 3D component 132 of a structure, e.g., to modify existing dimensions, incorporate additional components, etc.

At block 230, a user may submit a query to the system for information. For example, in scenario 100, user 110 may submit a query for “roofing configurations.”

At block 240, the user may receive results responsive to the submitted query from the system. For example, in scenario 100, such results may correspond to data 134 retrieved by system 101 responsive to the query for “roofing con-figurations.”

Should the user desire to refine the query based on the retrieved results, the user may formulate a refined query at block 245, and the workflow may return to block 240 to submit the refined query. Otherwise, the user may utilize the information from the retrieved results to continue editing/modifying the project file at block 220.

While system 101 and workflow 200 make it convenient for a user to work with and manipulate 3D components, it would be desirable to equip virtual and augmented reality systems with enhanced capabilities to increase user productivity. In particular, it would be desirable to provide techniques for efficiently identifying and retrieving three-dimensional and/or other types of data that take advantage of the distinct environment afforded by virtual and augmented reality systems.

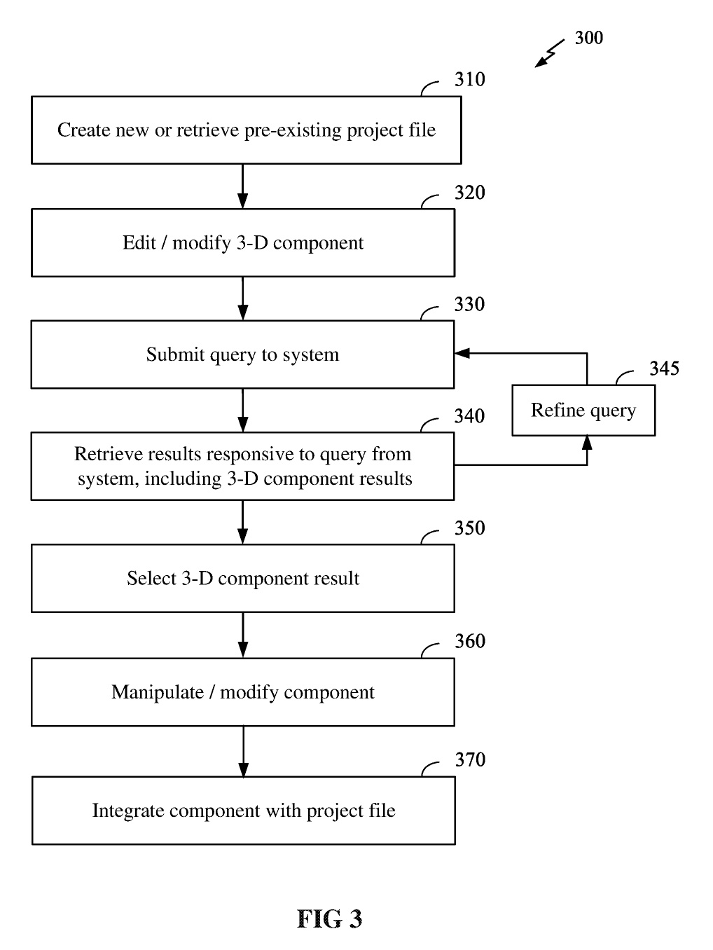

FIG. 3 illustrates an alternative exemplary embodiment of a method 300 for a workflow using a system 401 according to the present disclosure. Note FIG. 3 is shown for illustrative purposes only, and is not meant to limit the scope of the present disclosure to any particular workflow shown. Along with FIG. 3, further reference will be made to FIG. 4, which illustrates an application of the workflow 300 to a design environment 400.

In FIG. 3, at block 310, a user may create a new project file, or retrieve a pre-existing one from system 401.

At block 320, a user may edit or modify a 3D component.

At block 330, a user may submit a query to the system for information.

At block 340, the user may receive results responsive to the submitted query from the system. In an exemplary embodiment, the results may include one or more 3D component results.

Should the user desire to refine the query based on the retrieved results, the user may formulate a refined query at block 345, and the workflow may return to block 340 to submit the refined query.

In an exemplary embodiment, at block 340, in addition to retrieving text and/or image results responsive to a user query, system 401 may further retrieve results corresponding to relevant 3D components that can be incorporated by the user into the rest of workflow 300. For example, the query submitted at block 330 may relate to a 3D component that user 110 desires to integrate into the project file.

With reference to illustrative scenario 400 in FIG. 4, data 434 may correspond to results retrieved (e.g., at block 340) in response to a query submitted (e.g., at block 330) for “roof configurations,” similar to data 134 in scenario 100. Data 434 may further include a collection 444 of sample 3D roof configurations. In particular data 434 may display icons 446 which are clickable to retrieve associated 3D models of the corresponding roof configurations. Such retrievable 3D models are denoted herein as “3D component results.”

Returning to workflow 300, at block 350, the user may select a specific one of the 3D component results retrieved at block 340. For example, in scenario 400, user 110 selects from sample roof configurations 446 a specific result corresponding to a “Kingpost” configuration 451. In an exemplary embodiment, user selection of a result may he made using any supported input modality, e.g., by applying one or more input gestures with her hands.

Upon selection of the “Kingpost” configuration 451, system 401 retrieves a 3D component 420 corresponding to such configuration. A 3D rendering 422 of component 420 is displayed in imagery 431, along with other details, e.g., component name 421 (e.g., “Kingpost_model_201.6”) and/or other details. Arrow 412 illustratively suggests the correspondence between the Kingpost configuration 451 and details 420, 422, etc.; however, it will be appreciated that arrow 412 need not be explicitly displayed in imagery 431.

At block 360 of workflow 300, the user may manipulate or modify 3D component 420 For example, user 110 may manipulate, edit, or otherwise modify visual rendering 422 of 3D component 420, e.g., by applying tilting, zooming, rotating (e.g., as suggested by arrow 436 in FIG. 4), etc. User 110 may perform such operations using one or more of the input modalities supported by system 401. User 110 may subsequently integrate 3D component 420 with the rest of the project file, which may include other 3D components such as component 132.

According to the present disclosure, various techniques are described for implementing a system having the capabilities described hereinabove. In an exemplary embodiment, the system may identify, retrieve, and manipulate three-dimensional components from one or more online sources, and allow for integration of such components into a pre-existing workflow.

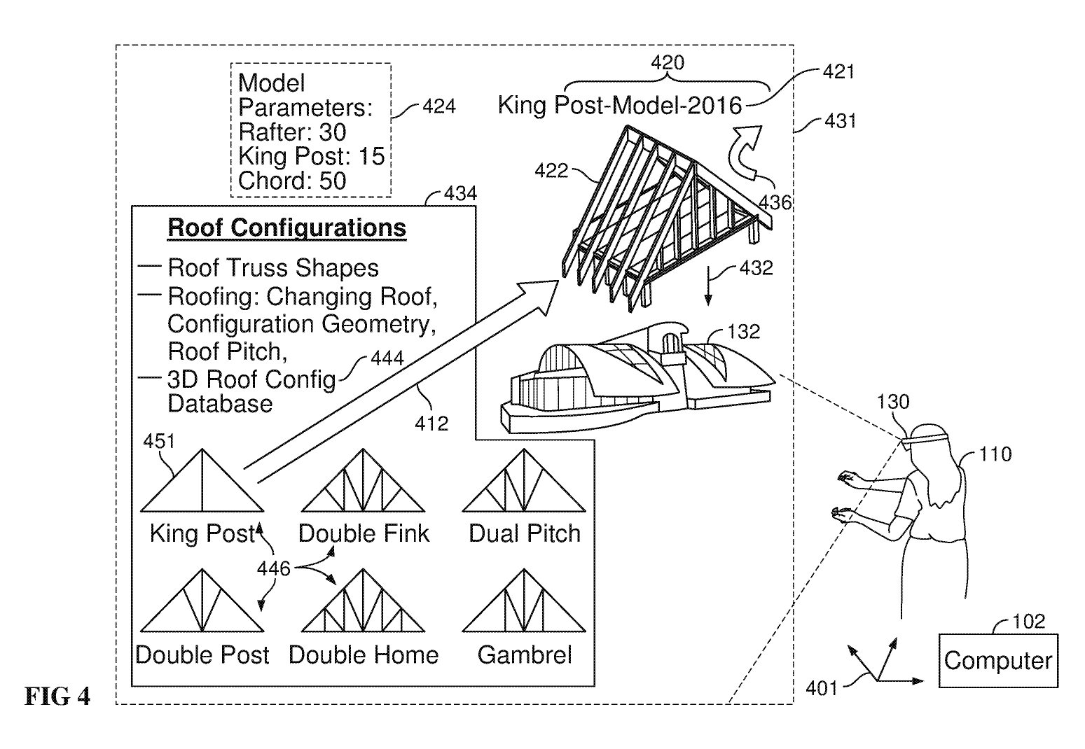

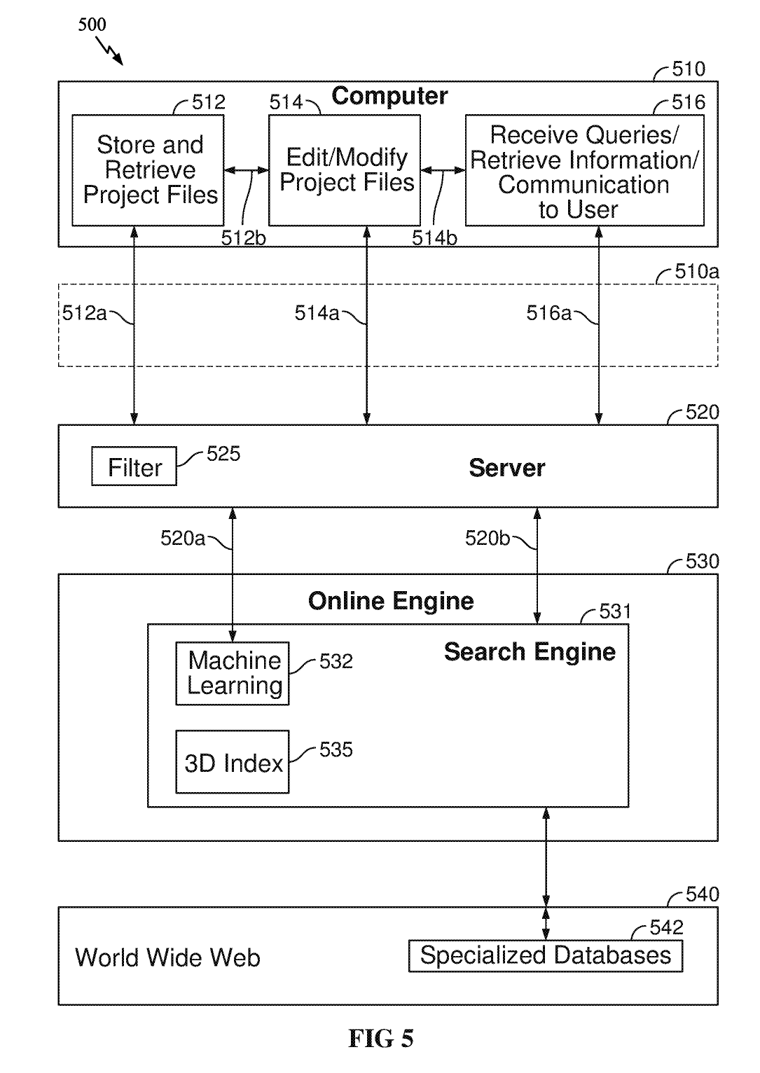

FIG. 5 illustrates an exemplary embodiment 500 of a system for implementing the functionality described hereinabove. Note FIG. 5 is shown for illustrative purposes only, and is not meant to limit the scope of the present disclosure to any particular implementations or functional partitioning of the blocks described. In certain exemplary embodiments, one or more of the functional blocks or module shown, e.g., computer 510 and server 520, may be integrated into a single module; conversely, functionality performed by a single module may be partitioned across multiple modules alternatively from what is shown. Such alternative exemplary embodiments are contemplated to be within the scope of the present disclosure.

In FIG. 5, computer 510 includes a plurality of modules for receiving input from a user, presenting output to the user, and communicating with other modules of system 500. In particular, computer 510 may include a module 512 for storing and retrieving project files. Computer 510 may further include a module 514 allowing editing and modifying of project files. Computer 510 may further include a module 516 that receives queries from a user, retrieves information responsive to queries, and communicates information to the user.

In an exemplary embodiment, computer 510 may be implemented as any type of computer directly accessible by the user, e.g., a desktop computer, laptop computer, smartphone, etc. Computer 510 may include one or more physically separate sub-modules for performing any of the functionality described, e.g., 3D glasses such as glasses 130 to display information to the user or other types of image displays. In an exemplary embodiment, computer 510 may incorporate computer 102 and/or glasses 130 described with reference to scenarios 200, 300 hereinabove.

In an exemplary embodiment, modules 512, 514, 516 of computer 510 may communicate with each other (e.g., as indicated by bidirectional arrows 512b, 514b) to exchange information and perform operations in sequence or in parallel, such as may be necessary to implement workflow 200 or 300 described hereinabove. For example, module 512 may continuously store (e.g., back up) a project file being edited through module 514, while user queries are simultaneously served through module 516, etc.

Computer 510 communicates with server 520 over a connection 510a, which may be, e.g., a wired, wireless, or any other type of connection. Connection 510a may include several logical channels 512a, 514a, 516a as described hereinbelow, as well as other logical channels not explicitly shown. In an exemplary embodiment, logical channels 512a, 514a, 516a may be carried over one or more physical channels.

In an exemplary embodiment, module 512 may store and retrieve project files on server 520 over channel 512a. Module 514 may communicate edits and modifications made by the user to project files to server 520 over channel 514a. For example, modifications made by user 110 to a 3D component such as component 132 in scenario 100 may be communicated to server 520 over channel 514a. Such modifications may include, e.g., details such as text edits, shape edits, sequence/order of project files selected and viewed, etc. In an exemplary embodiment, module 514 may selectively communicate such details over channel 514a, e.g., some details may be omitted, while others may be communicated, according to pre-configured rules.

Module 516 may communicate with server 520 over channel 516a. In particular, queries submitted by the user to module 516 of computer 510 may be communicated to server 520, which may in turn retrieve relevant results either internally or from another online source, e.g., online engine 530 as further described hereinbelow. In such an exemplary embodiment, server 520 may be understood to perform an intermediary function, communicating queries from computer 510 to engine 530, and/or results from engine 530 to computer 510, etc. Other details may also be communicated over one or more channels not shown in connection 510a, including, but not limited to, user identity, frequency or timing of access to the files or the system, etc.

In an exemplary embodiment, computer 510 and server 520 may be “local” or “internal” elements, e.g., they may belong to or be controlled by an entity to which the user also belongs. For example, in an exemplary embodiment wherein the user is an architect using workflow 300 to create an architectural design, computer 510 may be a personal computer used by the user for work purposes, while server 520 may be wholly or in part administered by the architectural firm to which the user belongs. Communications between computer 510 and server 520 may thus be considered “local” or “internal.” On the other hand, during a workflow such as 200, 300, it is sometimes advantageous for the user to access resources that are “remote” or “external,” such as an online database, search engine, etc., not under administration of the local entity. Such external resources may be, e.g., more extensive and/or comprehensive than what is available internally.

In FIG. 5, online engine 530 represents such an external resource. Online engine (or “engine”) 530 includes a search engine 531 with access to the World Wide Web 540, including certain specialized databases 542 as further described hereinbelow. Search engine 531 includes a machine learning module 532. In an exemplary embodiment, module 532 may be a component that “learns” to map queries submitted to search engine 531 to relevant results with increasing accuracy over time. Module 532 may employ techniques derived from machine learning, e.g., neural networks, logistic regression, decision trees, etc.

In an exemplary embodiment, server 520 may supply processed versions of information conveyed over connection 510a to machine learning module 532 of online engine 530 using channels 520a and 520b. In particular, channel 520b may convey the contents of a user query submitted by the user of computer 510, e.g., as processed by module 516, from server 520 to engine 530. Channel 520b may also convey the results generated by engine 530 responsive to the submitted user query from engine 530 back to server 520.

Channel 520a may convey certain training information from server 520 to engine 530 that is useful to train machine learning module 532 of search engine 531. For example, a user identity of a user of computer 510 may be conveyed to machine learning module 532 over channel 520a. Certain contents or characteristics of project files, e.g., as received from module 512 over channel 510a, as well as certain edits and modifications of project tiles, e.g., as received from module 514 over channel 514a, may also be conveyed to module 532 over channel 520a, Such received data may be utilized by online 530 to train machine learning module 532 to better process and serve queries submitted to search engine 531.

As an illustrative example, user 110 in scenario 400 may have a corresponding user identity, e.g., associated with user alias “anne123.” anne123 may participate in editing multiple architectural project files, e.g., MuseumFile1 associated with a museum design, and ConcertHallFile2 associated with a concert hall, etc. Edits made to such project files may include, e.g., selecting a specific architectural style such as “Rococo” for certain structures added to the museum design, etc.

Assuming such information is made available to train machine learning module 532 of online engine 530, e.g., over channel 520a, search engine 531 may advantageously serve more relevant and accurate results to submitted queries. For example, in response to a query submitted by anne123 for “rooftop configurations,” search engine 531 may rank certain search results relating to rooftop configurations for museums or concert halls more highly, or further prioritize museum over concert hall configurations based on MuseumFile1 being edited more recently than ConcertHallfile2, or rank Rococo-style configurations more highly, etc. Note the preceding discussion is provided for illustrative purposes only, and is not meant to limit the scope of the present disclosure to any particular types of information or techniques for processing and/or determining patterns in such information that may be employed by machine learning module 532.

In an exemplary embodiment, server 520 may perform certain processing on data received from computer 510, e.g., over connection 510a, prior to conveying such data to online engine 530. In particular, as server 520 and computer 510 may be internal elements, e.g., under the administration of the same entity to which the user belongs, while online engine 530 may be an external element, it may be desirable in certain cases for server 520 to remove certain sensitive or confidential information prior to sending data over channel 520a to engine 530. In an exemplary embodiment, such functionality may he performed by a filter 525 on server 520.

As earlier described with reference to block 340 of workflow 300, search results returned by search engine 531 may include one or more 3D component results. In an exemplary embodiment, one or more specialized databases 542 organizing and storing 3D models may be accessible by online engine 531 to generate such 3D component results, For example, one or more databases may be utilized that specifically collects and annotates 3D models, e.g., based on specialty field (e.g., “architecture” or “human anatomy,” etc.), type of 3D models (“rooftop configuration model,” etc.).

In an alternative exemplary embodiment, search engine 531 may itself generate its own 3D index 535 containing links to online-accessible 3D models that are variously distributed across the Internet. In an exemplary embodiment, search engine 531 may incorporate 3D component results from 3D index 535 and/or specialized databases 542 when responding to user queries. Such results may further be ranked for relevance using machine learning module 532 as earlier described hereinabove.

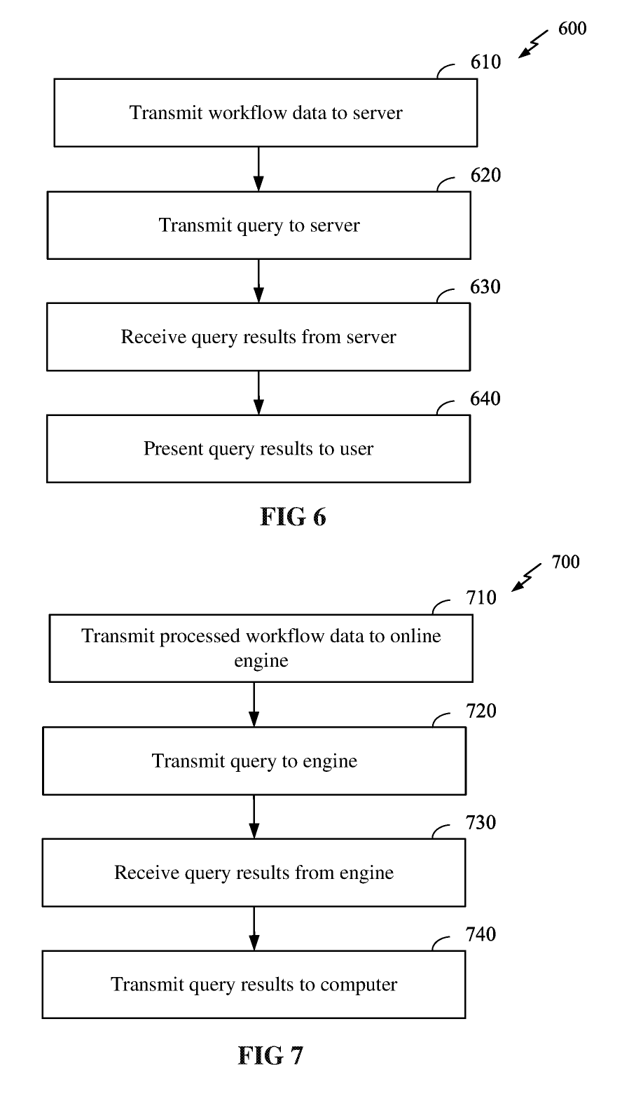

FIG. 6 illustrates an exemplary embodiment of a method 600 executed by computer 510 during workflow 300, described with reference to system 500. Note FIG. 6 is shown for illustrative purposes only, and is not meant to limit the scope of the present disclosure to any particular method shown. Note computer 510 may generally perform a diverse array of functions, only some of which are explicitly described in method 600 for clarity.

In FIG. 6, at block 610, computer 510 transmits workflow data to server 520. In an exemplary embodiment, workflow data may include any data relating to workflow 200 or 300, including, but not limited to, data communicated over channels 512a, 514a described hereinabove. At block 620, a query received from the user, e.g., at block 330 of workflow 300, is transmitted to server 520. At block 630, results responsive to the query transmitted at block 620 are received. At block 640, the received query results are presented to the user.

FIG. 7 illustrates an exemplary embodiment of a method 700 executed by server 520 during workflow 300. Note FIG. 7 is shown for illustrative purposes only, and is not meant to limit the scope of the present disclosure to any particular method shown. Note server 520 may generally perform a diverse array of functions, only some of which are explicitly described in method 700 for clarity.

In FIG. 7, at block 710, server 520 transmits processed workflow data to online engine 530. At block 720, a user query is transmitted to engine 530. In an exemplary embodiment, the transmitted query at block 720 may correspond to the user query transmitted from computer 510 at block 620. At block 730, results responsive to the query transmitted at block 720 are received from engine 530. At block 740, the received query results are transmitted to computer 510.

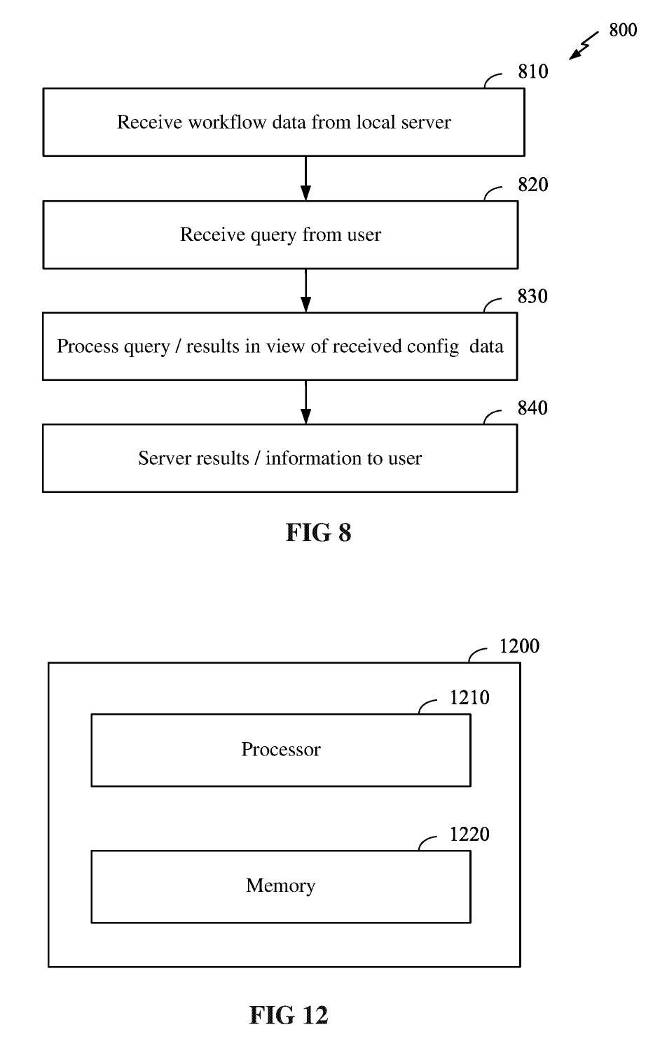

FIG. 8 illustrates an exemplary embodiment of a method 800 executed by online engine 530 during workflow 300. Note FIG. 8 is shown for illustrative purposes only, and is not meant to limit the scope of the present disclosure to any particular method shown. Note engine 530 may generally perform a diverse array of functions, only some of which are explicitly described in method 800 for clarity.

In FIG. 8, at block 810, engine 530 receives workflow data from a local server, e.g., server 520. At block 820, a query is received from the user. At block 830, the received query is processed, and relevant results are retrieved. Furthermore, the retrieved results may further be processed, e.g., ranked or filtered for relevance. It will be appreciated that such processing may utilize workflow data received, e.g., at block 810, to refine and increase the relevance of results presented to the user. At block 840, the processed results may be served to the user.

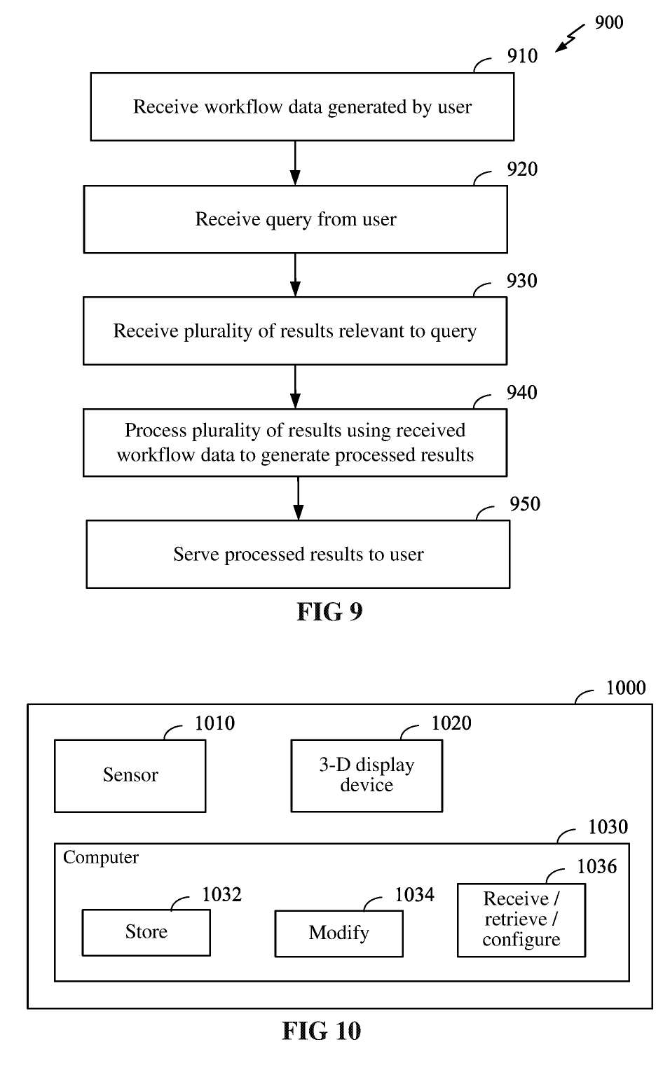

FIG. 9 illustrates an exemplary embodiment of a method 900 according to the present disclosure. Note method 900 is shown for illustrative purposes only, and is not meant to limit the scope of the present disclosure.

In FIG. 9, at block 910, workflow data generated by a user is received.

At block 920, a query from the user is received.

At block 930, a plurality of results relevant to said query is received. Said plurality of results may comprise a 3D component.

At block 940, said plurality of results is processed using said received workflow data to generate processed results. In an exemplary embodiment, such processing comprises training one or more machine learning algorithms using said workflow data to generate a ranking score for each of said plurality of results;

At block 950, said processed results are served to the user.

FIG. 10 illustrates an exemplary embodiment of an apparatus 1000 according to the present disclosure. Note apparatus 1000 is shown for illustrative purposes only, and is not meant to limit the scope of the present disclosure.

In FIG. 10, apparatus 1000 comprises a sensor 1010 for receiving at least one input modality from a user; a three-dimensional (3D) display device 1020 configured to display three-dimensional imagery to the user; and a computer 1030. Computer 1030 may comprise: a module 1032 for storing at least one project file; a module 1034 for modifying said at least one project file according to said received at least one input modality; a module 1036 for receiving a query, retrieving results responsive to said query, and configuring the 3D display device to display said retrieved results, said results comprising a 3D component.

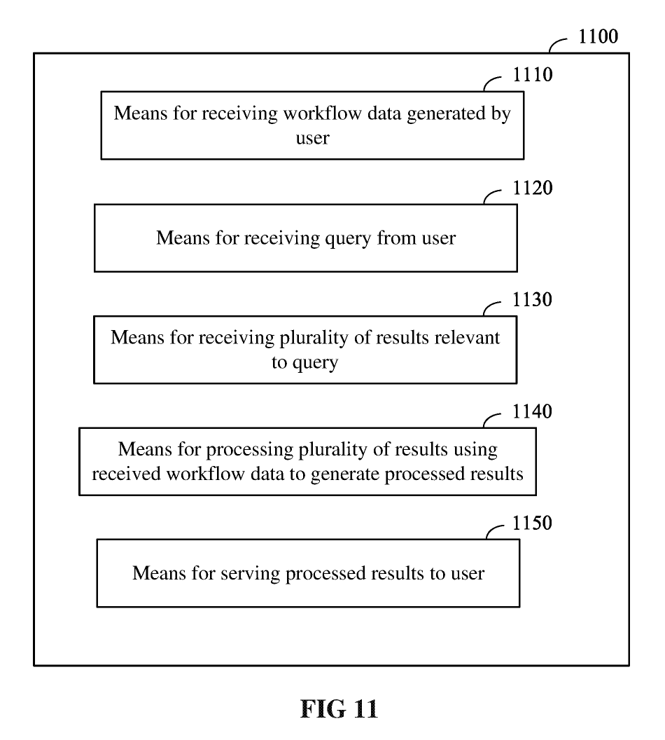

FIG. 11 illustrates an alternative exemplary embodiment of an apparatus 1100 according to the present disclosure. Note apparatus 1100 is shown for illustrative purposes only, and is not meant to limit the scope of the present disclosure.

In FIG. 11, apparatus 1100 comprises: means 1110 for receiving workflow data generated by a user; means 1120 for receiving a query from the user; means 1130 for retrieving a plurality of results relevant to said query, said plurality of results comprising a 3D component; means 1140 for processing said plurality of results using said received workflow data to generate processed results; and means 1150 for serving said processed results to the user:

In an exemplary embodiment, said means 1140 for processing said plurality of results using said received workflow data may comprise means for training one or more machine learning algorithms using said workflow data to generate a ranking score for each of said plurality of results. Such means for training may include a computer system that updates one or more weights of a machine learning algorithm according to said workflow data. For example, if workflow data includes a project title such as “church design,” then such machine learning algorithm may be trained in such a manner that subsequent queries for “rooftop configurations” may likely generate results for rooftop configurations particularly relevant to church designs.

FIG. 12 illustrates an exemplary embodiment of a computing device 1200 according to the present disclosure. Note FIG. 12 is shown for illustrative purposes only, and is not meant to limit the scope of the present disclosure to any particular computing device shown.

In FIG. 12, computing device 1200 includes a processor 1210 and a memory 1220 holding instructions executable by the processor to: receive workflow data generated by a user; receive a query from the user; retrieve a plurality of results relevant to said query, said plurality of results comprising a 3D component; process said plurality of results using said received workflow data to generate processed results; and serving said processed results to the user.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

The functionality described herein can be performed, at least in part, by one or more hardware and/or software logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCA Complex Programmable Logic Devices ( CPLDs), etc.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A method comprising:
receiving workflow data generated by a user;
receiving a query from the user;
retrieving a plurality of results relevant to said query, said plurality of results comprising a 3D component;
processing said plurality of results using said received workflow data to generate processed results, said processing comprising training one or more machine learning algorithms using said workflow data to generate a ranking score for each of said plurality of results; and
serving said processed results to the user based on the generated ranking scores.

2. The method of claim 1, said workflow data comprising parameters of an associated project tile.

3. The method of claim 2, said parameters comprising edits or modifications made to the associated project file,

4. The method of claim 1, said workflow data comprising a user identity.

5. The method of claim 1, said retrieving comprising retrieving results from a 3D index comprising links to online-accessible 3D models.

6. The method of claim 1, said retrieving comprising retrieving results from specialized databases organizing and storing 3D models.

7. The method of claim 1, further comprising receiving a selection by said user of one of said served processed results, the received selection further being used to train said one or more machine learning algorithms.

8. The method of claim 1, said serving said processed results comprising displaying said processed results sequentially according to their corresponding ranking scores.

9. An apparatus comprising:
a sensor for receiving at least one input modality from a user;
a three-dimensional (3D) display device configured to display three-dimensional imagery to the user;
a computer comprising:
a module for storing at least one project file;
a module for modifying said at least one project file according to said received at least one input modality;
a module for receiving a query, retrieving results responsive to said query, and configuring the 3D display device to display said retrieved results, said results comprising a 3D component.

10. The apparatus of claim 9, the computer further comprising a module for sending workflow data associated with the at least one project file to a server.

11. The apparatus of claim 10, said workflow data comprising edits or modifications made to the associated project file.

12. The apparatus of claim 10, said workflow data comprising a user identity.

13. The apparatus of claim 10, said 3D component comprising a result algorithmically determined to be relevant to said query based on said workflow data.

14. The apparatus of claim 9, the sensor comprising at least one camera for sensing a gesture of said user

15. The apparatus of claim 9, the sensor comprising at least one microphone for receiving an audio input from said user.

16. The apparatus of claim 9, the 3D display device comprising glasses worn by said user.

17. An apparatus comprising:
means for receiving workflow data generated by a user;
means for receiving a query from the user;
means for retrieving a plurality of results relevant to said query, said plurality of results comprising a 3D component;
means for processing said plurality of results using said received workflow data to generate processed results, said means for processing comprising means for training one or more machine learning algorithms using said workflow data to generate a ranking score for each of said plurality of results; and
means for serving said processed results to the user.

18. The apparatus of claim 17, said workflow data comprising parameters of an associated project file.

19. The apparatus of claim 18, said parameters comprising edits or modifications made to the associated project file.

20. The apparatus of claim 17, said workflow data comprising a user identity.
